(19) United States
(12) Patent Application Publication
(10) Pub. No.: US 2006/0088656 A1
(43) Pub. Date: Apr. 27, 2006

(54) Manufacturing donor substrates for making OLED displays

(75) Inventor: Donald R. Preuss, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/972,600

(22) Filed: Oct. 25, 2004

(51) Int. Cl. B05D 5/06

(52) U.S. Cl. 427/66

(57) ABSTRACT

A method for coating a light absorbing region onto a support in making a donor substrate includes forming the support into a support roll and packaging the support roll in a moisture resistant material or container, removing the moisture resistant material or the container from the support roll and placing the support roll into a vacuum coating system. The method also includes unwinding the support roll and passing the support over a first and a second deposition source, the first deposition source includes an antireflection material for coating an antireflection layer and then past the second deposition source which includes a material for coating a light absorbing layer to thereby complete the light absorbing region, and controlling the thickness of the antireflection layer and the light absorbing layer so as to maximize the fraction of incident light which passes through the support and is absorbed within the light absorbing region.

### FIELD OF THE INVENTION

The present invention relates to the making of coated donor substrates for organic light-emitting diode (OLED) display devices.

### BACKGROUND OF THE INVENTION

Organic light-emitting diodes (OLEDs) are useful in a variety of applications, including watches, telephones, laptop computers, pagers, cellular phones, calculators, and the like. Conventional OLED display devices are built on glass substrates in a manner such that two-dimensional OLED arrays for image manifestation are formed. The basic OLED cell structure includes a stack of thin organic layers sandwiched between an array of anodes and a common metallic cathode. The organic layers comprise a hole transport layer (HTL), an emissive layer (EL), and an electron transport layer (ETL). When an appropriate voltage is applied to the cell, the injected holes and electrons recombine in the EL near the EL-HTL interface to produce light (electroluminescence).

The EL within a color OLED display device most commonly includes three different types of fluorescent molecules that are repeated through the EL. Red, green, and blue regions, or subpixels, are formed throughout the EL during the manufacturing process to provide a two-dimensional array of pixels.

There exist a variety of methods for patterning OLED display devices in order to obtain subpixels of desired colors in an integrated device. U.S. Pat. No. 6,384,529 describes a full-color active matrix organic light-emitting color display panel that has an integrated shadow mask structure for patterning arrays of color subpixels. U.S. Pat. No. 6,214,631 describes a method of fabricating a device in which a shadow mask is positioned in a first position over a substrate. A first process is performed on the substrate through the shadow mask. After the first process is performed, the shadow mask is moved to a second position over the substrate, measured relative to the first position. After the shadow mask is moved to the second position, a second process is performed on the substrate through the shadow mask.

U.S. Pat. No. 5,953,587 describes a patterning system with a photo-resist overhang that permits material to be deposited onto a substrate in various positions by varying the angle from which the material is deposited and by rotating the substrate. The patterning system can be used to fabricate a stack of organic light-emitting devices on a substrate using the same patterning system and without removing the substrate from vacuum.

U.S. Pat. No. 5,937,272 describes a method of forming high-definition patterned organic layers in a full-color electroluminescent (EL) display array on a two-dimensional thin film transistor (TFT) array substrate. The substrate has subpixels with each subpixel having raised surface portions and one recessed surface portion that reveals a bottom electrode. Red, green, and blue color forming organic EL layers are formed in the designated subpixels in accordance with a selected color pattern. The method uses a donor support that is coated with a transferable coating of an organic EL material. The donor support is heated to cause the transfer of the organic EL material onto the designated recessed surface portions of the substrate forming the colored EL medium in the designated subpixels. Optical masks and, alternatively, an aperture mask are used to selectively vapor deposit respective red, green, and blue organic EL media into the designated color EL subpixels.

U.S. Pat. No. 6,790,594 describes a high absorption donor substrate, which can be used in a laser thermal transfer process to pattern organic materials during the fabrication of an EL display device, particularly an OLED display device.

OLEDs are prone to damage from a variety of environmental conditions, namely oxygen, moisture, and ultraviolet light. Extensive precautions are taken to limit exposure of OLEDs to any of these damaging conditions, both during manufacturing and in the final product. Widespread adoption of OLED technology is currently limited by the poor environmental stability of the devices.

Conventional OLEDs are bottom-emitting (BE), meaning that the display is viewed through the substrate that supports the OLED structure. In BE OLEDs, the circuitry (bus metals, thin film transistors [TFTs], and capacitors) is competing with pixel-emitting areas for space in the displays. This competition for space results in two major issues that limit display performance: 1) a higher drive current density is required to achieve equivalent image quality and this higher drive current density leads to poorer device stability; and 2) more complex pixel drive circuitry cannot be readily implemented without compromising additional emitting area.

Top-emitting (TE) OLED configurations are being developed where the emission exits the OLED through the free surface of the device (away from the substrate). Consequently, the anode can be formed over opaque drive circuitry. This configuration has potential to improve display performance compared with BE OLEDs by: 1) increasing the aperture ratio, therefore permitting the pixel to operate at a lower current density with improved stability; 2) permitting more complex drive circuitry to enable better control of pixel current, leading to enhanced display performance (uniformity, stability); 3) enabling lower mobility materials, e.g., amorphous silicon, to be considered for TFT fabrication; and 4) permitting schemes for increasing the emission out coupling (increased efficiency) that are not available for the bottom-emitting format. However, there are new challenges in establishing a cost effective deposition process that both provides such an increased aperture ratio and is well suited for the high-throughput making of OLED display devices.

Laser thermal transfer is a deposition process that holds promise for the enhanced fill and more precise patterning of subpixels throughout the EL. In laser thermal transfer, a donor sheet having the desired organic material is placed into close proximity to the OLED substrate within a vacuum chamber. A laser impinges through a clear support that provides physical integrity to the donor sheet and is absorbed within a light absorbing layer contained atop the support. The conversion of the laser's energy to heat sublimates the organic material that forms the top layer of the donor sheet and thereby transfers the organic material in a desired subpixel pattern to the OLED substrate. While laser thermal transfer is a less mature technology than more conventional deposition processes, such as precision shadow masking, laser thermal transfer is well suited to provide more precise and flexible patterning of subpixels throughout the EL.

U.S. Pat. No. 6,485,884 provides a method for patterning oriented materials to make OLED display devices. The method includes selective thermal transfer of an oriented electronically active or emissive material from a thermal transfer donor sheet to a receptor. U.S. Pat. No. 6,485,884 also provides donor sheets for use with the method, and methods for making donor sheets that include transfer layers having oriented electronically active organic materials. However, the method for providing the donor sheets is not well suited to the high-throughput production necessary to realize cost effective utilization of thermal transfer during the making of OLED display devices. Further, the method for providing the donor sheets described by U.S. Pat. No. 6,485,884 does not prevent moisture absorption by the donor sheets during their making and handling. The moisture content of a donor sheet is a critical parameter, and the simple exposure of a donor sheet to ambient atmospheric conditions can greatly elevate its moisture content. Moisture contents of more than 0.2 percent can impact the adhesion of the layers coated onto the donor sheet, causing ablation rather than sublimation during the transfer process. Moisture contents of less than 0.02% can adversely affect the organic materials as they are coated onto the thermal transfer donor sheet, or as they are transferred from the donor sheet to the receptor. In either case, the quality and uniformity the organic EL material that is transferred from the donor sheet to the OLED substrate is greatly compromised. It is important, therefore, to prevent the donor substrate from absorbing any moisture during its making.

### SUMMARY OF THE INVENTION

It is therefore an object of the invention to provide an effective way for making donor substrates for use in laser thermal transfer of organic material during the making of OLED display devices.

This object is achieved in a method for coating a light absorbing region onto a support in making a donor substrate that is used in making OLED display devices, comprising:

a) forming the support into a support roll and packaging the support roll in a moisture resistant material or container to prevent the support roll from absorbing moisture;

b) removing the moisture resistant material or the container from the support roll and placing the support roll into a vacuum coating system;

c) unwinding the support roll and passing the support over a first and a second deposition source, the first deposition source includes an antireflection material for coating an antireflection layer and then past the second deposition source which includes a material for coating a light absorbing layer to thereby complete the light absorbing region; and

d) controlling the thickness of the antireflection layer and the light absorbing layer so as to reduce the fraction of incident light which passes through the support and is converted to either transmitted light or reflected light by the light absorbing region.

### ADVANTAGES

This invention provides high-throughput, control of water content, and uniformity of optical properties, which are essential to the successful use of the donor substrate in the thermal transfer process used in patterning the pixels in an OLED display device.

### BRIEF DESCRIPTION OF THE DRAWINGS

FIG. 1 illustrates a donor element in accordance with the present invention;

FIG. 2 is a block diagram that illustrates a laser thermal transfer process that can be used in accordance with the present invention;

FIG. 3 is a block diagram that illustrates a manufacturing process for making donor substrates in accordance with the present invention;

FIG. 4 is a schematic which illustrates a vacuum coating system usable in accordance with the present invention;

FIG. 5 is a block diagram that illustrates a method for the high-throughput controlled environment making of donor substrates; and

FIG. 6 is a graph that illustrates the calculated optical density of silicon versus thickness of the silicon layer on Udel support for various optical wavelengths.

### DETAILED DESCRIPTION OF THE INVENTION

The present invention is a controlled, ultra low humidity, high-throughput system for and method of manufacturing donor substrates that are used during the deposition of organic EL material during the making of OLED display devices.

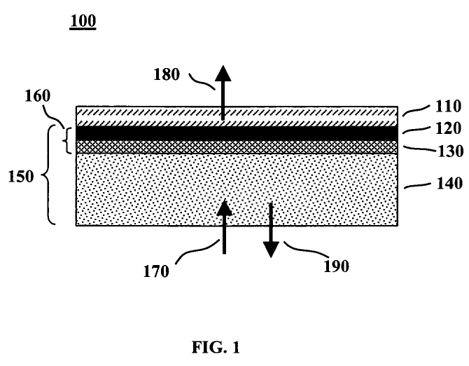

FIG. 1 illustrates a donor element 100 that includes a support 140 fabricated from high temperature polymeric material such as a thermoplastic with an aromatic backbone. Deposited atop support 140 is a light absorbing region 160 including an antireflecting layer 130 such as silicon and a light absorbing layer 120 such as metallic chromium. Alternate choices for antireflecting layer 130 generally include a wide range of semiconductors or chalcoginides, more specifically, germanium, AlSb, As₂S₃, GaAs, GaP, GaIn, PbTe, PbS, or InP. Alternate choices for light absorbing layer 120 generally include stable metals with high melting points, more specifically, Ni, V, W, Pt, Pd, Ir, or Os. Support 140, antireflecting layer 130, and light absorbing layer 120 form a donor substrate 150, atop which is deposited an organic transfer layer 110. Donor element 100 is then used during laser thermal transfer of organic material during the making of an OLED display device. After incident light 170 passes through support 140, much of it is converted to heat by light absorbing region 160. This process is made efficient by reducing the fraction of incident light 170 which is converted to either transmitted light 180 or reflected light 190.

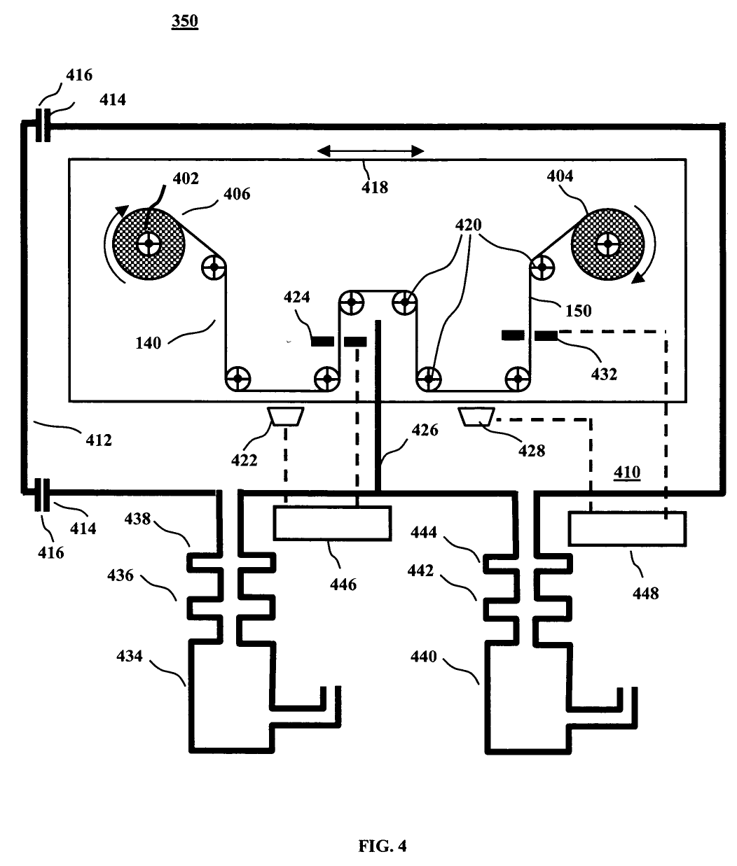

Support 140 is supplied in the form of a large extruded roll that is, in one example, 3 mills thick, 26 inches wide, and hundreds of yards long, and is sealed in a protective humidity resistant coating such as a metallized Mylar film. Desiccant can be added to the packaging to further prevent support 140 from absorbing moisture. Antireflecting layer 130 and light absorbing layer 120 are deposited in appropriate thicknesses in a series of deposition processes (described with reference to FIG. 4) to form donor substrate 150. It is of critical importance to maintain support 140 in a dry state during the making of donor substrate 150.

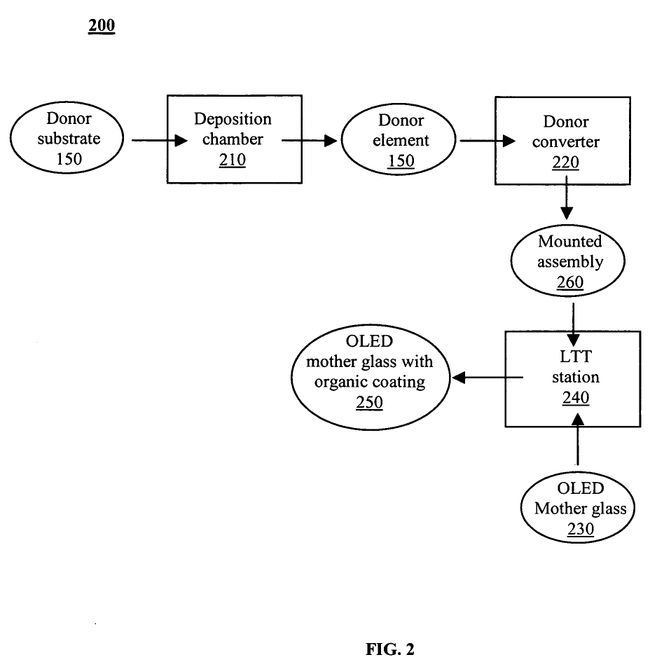

To better understand the specific manufacturing requirements of donor substrate 150, FIG. 2 illustrates how donor substrate 150 can be used in an exemplary simplified laser thermal transfer process 200 step of OLED display making. Laser thermal transfer process 200 includes donor substrate 150, which undergoes the deposition of organic transfer layer 110 within an appropriate deposition chamber 210 to form donor element 100. Laser thermal transfer process 200 further includes a donor converter 220 that converts donor element 100 to a mounted assembly 260 suitable for use in a laser thermal transfer (LTT) station 240, in which an OLED mother glass 230 becomes OLED mother glass with organic coating 250 as a result of the laser thermal transfer of organic transfer layer 110 from donor element 100 to OLED mother glass 230. OLED mother glass 230 is the substrate atop which an OLED display device is built, and includes the appropriate anodes and drive circuitry, such as a series of thin film transistors (TFTs).

In operation, organic transfer layer 110 is deposited atop donor substrate 150 within deposition chamber 210, thus forming donor element 100. Donor element 100 is converted by donor converter 220 to a mounted assembly suitable for use in LTT station 240. OLED mother glass 230 and converted donor element 100 are positioned within LTT station 240 in a predefined proximity to one another and a laser impinges upon donor element 100 through support 140 to transfer a predefined pattern of the constituents of organic transfer layer 110 to OLED mother glass 230. The combination of light absorbing layer 120 and antireflecting layer 130 causes nearly 100 percent of the incident laser light to be absorbed and converted to heat within the light absorbing region 160. Upon conversion of the laser energy to heat within light absorbing region 160, organic transfer layer 110 vaporizes via sublimation and transfers to OLED mother glass 230, thereby forming OLED mother glass with organic coating 250.

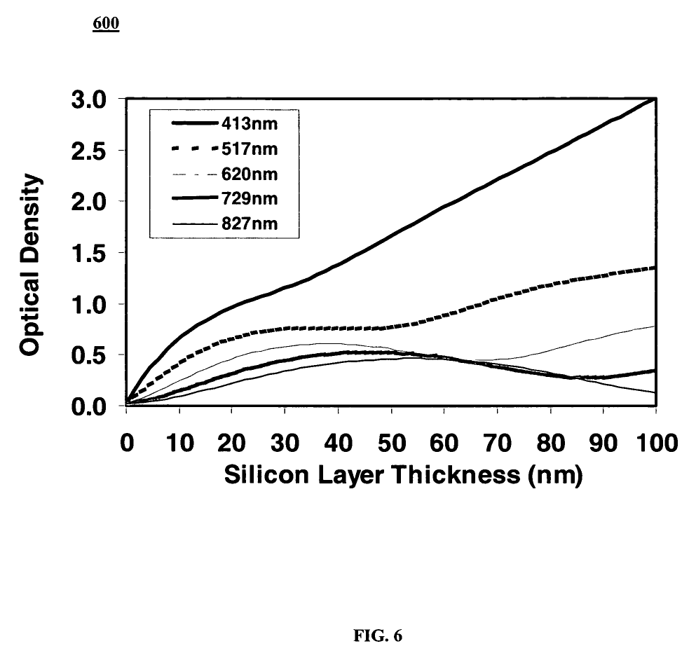

Light absorbing layer 120 and antireflecting layer 130 are chosen such that light absorbing layer 120 absorbs nearly 100 percent of the energy of a given wavelength laser for a particular application. The choice of light absorbing layer 120 and antireflecting layer 130 is empirically determined by material compatibility at a range of thicknesses and material choices. In one embodiment, antireflecting layer 130 is 40 nm of Si and light absorbing layer 120 is 40 nm of Cr. The tuning of antireflecting layer 130 and light absorbing layer 120 is described in detail with reference to FIG. 6.

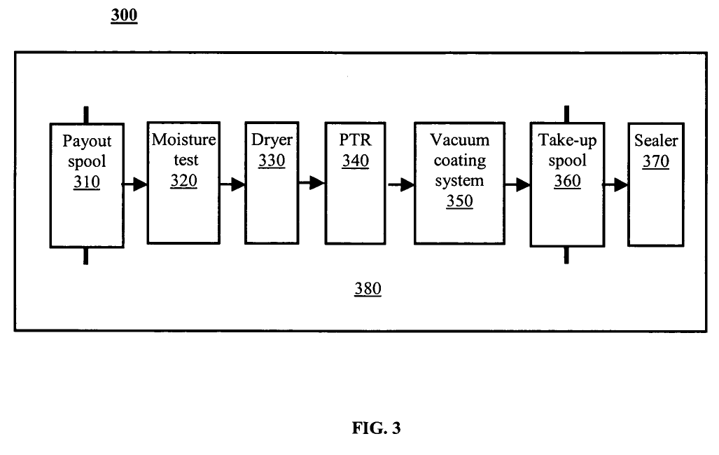

FIG. 3 illustrates an inline manufacturing process 300 for the formation of donor substrate 150. Manufacturing process 300 includes a moisture test 320, a dryer 330, a particle transfer roller (PTR) 340, a vacuum coating system 350, and a sealer 370. PTR 340 is one or more soft urethane rollers that come into contact with support 140 and remove loose particles. PTR 340 can be housed in a vacuum environment or can be maintained under ambient conditions. Dryer 330 is an optional heating chamber such as a large oven that can be included in manufacturing process 300 if moisture test 320 determines that additional moisture should be removed from support 140 before subjecting support 140 to cleaning and deposition. Fourier transform infrared (FTIR) spectroscopy is one example of a nondestructive testing method that is well suited for adaptation as moisture test 320. Any moisture present within support 140 provides a signature readily detectable by FTIR spectroscopy. Sealer 370 provides a package around the take-up spool of a material with a low permeability to water, such as a metallized Mylar film. The package can also be supplied with a desiccant which will absorb, or react with any moisture which does (over time) penetrate the package material. A dry environment 380 is provided throughout the entire manufacturing process 300. Further included in FIG. 3 for illustrative purposes is a payout spool 310 housing uncoated support 140 and a take-up spool 360 housing coated donor substrate 150.

In operation, dry environment 380 is provided during the entire manufacturing process 300 to prevent support 140 and, ultimately, donor substrate 150 from absorbing moisture. Moisture test 320 is performed upon support 140 to determine the moisture content of support 140. If it is determined that the moisture content of support 140 is unacceptable, dryer 330 can provide additional drying to support 140. Upon attaining acceptable moisture content within support 140, loose particulate matter is removed from support 140 by PTR 340. The dry, particle-free support 140 is next subjected to one or more deposition processes within vacuum coating system 350 to obtain the desired layer(s) atop support 140. Vacuum coating system 350 is described in detail with reference to FIG. 4. Upon receiving the appropriate depositions within vacuum coating system 350, donor substrate 150 is wound onto take-up spool 360 and is hermetically sealed within sealer 370 to await delivery to an OLED manufacturing facility.

It is a matter of engineering design whether the dried and cleaned substrate emerging from PTR 340 is fed directly into vacuum coating system 350 on a continuous basis as shown, or if the substrate is wound onto an intermediate spool (not shown), and placed as a roll into the vacuum coating system 350 for pumpdown and vacuum coating in a batch mode.

FIG. 4 illustrates vacuum coating system 350, including a vacuum chamber 410, wherein deposition is to occur, that further includes a removable panel 412 formed of one of the walls of vacuum chamber 410 and a pair of flanges 414 and 416. Vacuum chamber 410 is physically connected to a pump 434 and a pump 440 that are large diffusion pumps housed in a floor below vacuum coating system 350. Pump 434 includes a valve 438 such as a large gate valve and a cryobaffle 436 that prevents oil from pump 434 from entering vacuum chamber 410. Similarly, pump 440 includes a valve 444 and a cryobaffle 442. Vacuum coating system 350 further includes a first source 422 and a second source 428 physically separated by a barrier 426 that are used to deposit antireflecting layer 130 and light absorbing layer 120, respectively. Vacuum coating system 350 further includes a support panel 418 that is capable of movement in a translational direction to facilitate the loading of support roll 406 onto vacuum payout spool 402 in the vacuum chamber 410 and the removal of donor substrate roll 408 from vacuum take-up spool 404 from vacuum chamber 410. Support panel 418 supports vacuum payout spool 402 and vacuum take-up spool 404, along with a plurality of guide rollers 420 that support and position uncoated support 140 as it unwinds from vacuum payout spool 402, undergoes deposition, to form donor substrate 150, and winds onto vacuum take-up spool 404 to form donor substrate roll 408. A coating monitor assembly 424 that optically measures the thickness of the coating applied to support 140 from the first source 422 is positioned at an appropriate location subsequent to the first source 422 and prior to the second source 428. The signal produced by coating monitor assembly 424 in response to the thickness of the coating provided by the first source 422 is fed into the power supply with feedback loop 446 which in turn controls the deposition rate of the first source 422. Similarly, a coating monitor assembly 432 that optically measures the thickness of the coating applied to support 140 from the second source 428 is positioned at an appropriate location subsequent to the second source 428. The signal produced by coating monitor assembly 432 in response to the thickness of the coating provided by the second source 428 is fed into the power supply with feedback loop 448 which in turn controls the deposition rate of the second source 428. Coating monitor assemblies 424 and 432 are fixedly attached to support panel 418.

Moisture test 320, dryer 330, and PTR 340 can be located within the confines of vacuum system 350, in which case payout spool 310 and vacuum payout spool 402 are one and the same part. Similarly, depending on engineering details, vacuum take-up spool 404 and take-up spool 360 can also be one and the same part.

In operation, vacuum chamber 410 is opened via the separation of flanges 414 and 416 and the retraction of removable panel 412 along a railroad track. Forklifts are used to transport rolls of support 140 into vacuum coating system 350. Support panel 418 translates to accommodate the loading and threading of rolls of support 140 through vacuum coating system 350. Support 140 is threaded via guide rollers 420 from vacuum payout spool 402 to vacuum take-up spool 404. Removable panel 412 is repositioned and flanges 414 and 416 are reconnected to seal vacuum chamber 410. Pumps 434 and 440 are turned on and vacuum chamber 410 is pressurized to an appropriate condition. Support 140 translates through vacuum coating system 350 at an appropriate translational velocity to achieve a desired deposition rate. First source 422 and second source 428 are evaporated, for example, using an electron beam, to transfer antireflecting layer 130 and light absorbing layer 120 material to support 140. In one embodiment, the first source 422 and the second source 428 are each four identical evaporation sources that are positioned along a line perpendicular to the plane of FIG. 4 to accommodate deposition across a 26-inch width of support 140. The deposition of material from the sources 422 and 428 is physically isolated by barrier 426. Feedback in the form of optical measurements of the thickness of antireflecting layer 130 and light absorbing layer 120 is provided to vacuum coating system 350 by coating monitor assemblies 424 and 432, respectively. The feedback is used to govern the power supplied to the electron beam that impinges upon sources 422 and 428 and the translational velocity of support 140 through vacuum coating system 350. In one embodiment, silicon and chromium are deposited as antireflecting layer 130 and light absorbing layer 120. In such a case, the thickness of silicon is of greater importance than the thickness of chromium, and coating monitor assembly 424 is optimized for silicon, for example, by selecting a blue light source and using blue transmitted light to detect the silicon thickness. Similarly, coating monitor assembly 432 is optimized for chromium by selecting a red or a white light source and using red or white transmitted or reflected light to detect the chromium thickness, as is described in detail with reference to FIG. 6.

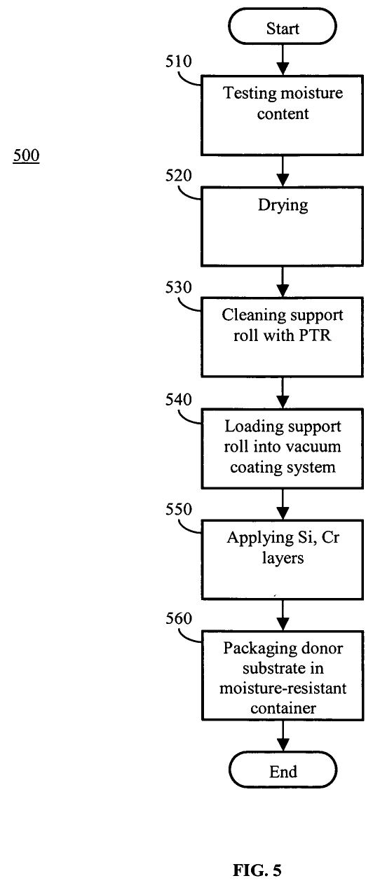

FIG. 5 illustrates a method 500 that is a high-throughput method of manufacturing donor substrate 150 in a manner that prevents moisture absorption by support 140. Method 500 includes the following steps:

In step 510, a roll of support 140 is obtained from a supplier and maintained in dry environment 380. Moisture test 320 is performed on support 140 to determine if additional drying is needed prior to the deposition of antireflecting layer 130 and light absorbing layer 120. Method 500 proceeds to step 520.

In step 520, moisture is removed from support 140 using dryer 330. Method 500 proceeds to step 530.

In step 530, PTR 340 contacts the roll of support 140. Loose particulate matter on support 140 adheres to PTR 340. Method 500 proceeds to step 540.

In step 540, the roll of support 140 is loaded into vacuum coating system 350. Method 500 proceeds to step 550.

In step 550, antireflecting layer 130 and light absorbing layer 120 are deposited atop support 140. Antireflecting layer 130 and light absorbing layer 120 (in one example, silicon and chromium, respectively) are tuned to optimally absorb close to 100 percent of a chosen laser wavelength's energy, as is described with reference to FIG. 6. Method 500 proceeds to step 560.

In step 560, the roll of donor substrate 408 is packaged in a moisture resisting material or container, such as a metallized Mylar film with added desiccant, and is stored until shipping. Method 500 ends.

FIG. 6 shows a graph 600 that illustrates the calculated optical density across a range of silicon layer thicknesses deposited atop Udel support 140 for various optical wavelengths.

The goal of monitoring antireflection layer 130 (silicon) with coating monitor assembly 424 is to determine the thickness of the silicon layer such that the entire donor substrate 150 (including antireflecting layer 130 and light absorbing layer 120) is tuned to a reflectivity minimum or an absorption maximum for the wavelength of the laser expected to be used for the sublimation of organic transfer layer 110 within LTT station 240. In the example illustrated by graph 600, the tuning of antireflecting layer 130 and light absorbing layer 120 is performed for a laser wavelength of 800 nm. In general, controlling a process through the detection of a property tuned to a minimum or maximum is undesirable because the sensitivity of the process to variation in the detected parameter is poorest at that point. It is more desirable to detect an untuned property. Thus, the absorption of transmitted blue light (410-490 nm), which graph 600 shows is the closest to monotonically increasing with increasing thickness of the silicon, is used by arranging a detector array in an appropriate manner to form coating monitor assembly 424.

In the case of the chromium layer, the transmission of red light or white light increases monotonically with chromium thickness, so the transmission of red light is an acceptable parameter for controlling the deposition process. Further, due to the fact that silicon absorbs only weakly in the red, the thickness of the silicon layer is decoupled from the optical measurement of chromium thickness. Thus, coating monitor assembly 432 is optimized accordingly to measure the thickness of light absorbing layer 120 by using transmitted or reflected white light.

The invention has been described in detail with particular reference to certain preferred embodiments thereof, but it will be understood that variations and modifications can be effected within the spirit and scope of the invention.

### PARTS LIST

100 donor element
110 organic transfer layer
120 light absorbing layer
130 antireflecting layer
140 support
150 donor substrate
160 light absorbing region
170 incident light
180 transmitted light
190 reflected light
200 laser thermal transfer process
210 deposition chamber
220 donor converter
230 OLED mother glass
240 LTT station
250 OLED mother glass with organic coating
260 mounted assembly
300 manufacturing process
310 payout spool
320 moisture test
330 dryer
340 PTR
350 vacuum coating system
360 take-up spool
370 sealer
380 dry environment
402 vacuum payout spool
404 vacuum take-up spool
406 support roll
408 donor substrate roll
410 vacuum chamber
412 removable panel
414 flange
416 flange
418 support panel
420 guide rollers
422 first source
424 coating monitor assembly
426 barrier
428 second source
432 coating monitor assembly
434 pump
436 cryobaffle
438 valve
440 pump
442 cryobaffle
444 valve
446 power supply with feedback loop
448 power supply with feedback loop
500 method
510 testing moisture content step
520 drying step
530 cleaning support roll with PTR step
540 loading support roll into vacuum coating system step
550 applying Si, Cr layers step
560 packaging donor substrate in moisture resistant container step
600 graph

1. A method for coating a light absorbing region onto a support in making a donor substrate that is used in making OLED display devices, comprising:
a) forming the support into a support roll and packaging the support roll in a moisture resistant material or container to prevent the support roll from absorbing moisture;
b) removing the moisture resistant material or the container from the support roll and placing the support roll into a vacuum coating system;
c) unwinding the support roll and passing the support over a first and a second deposition source, the first deposition source includes an antireflection material for coating an antireflection layer and then past the second deposition source which includes a material for coating a light absorbing layer to thereby complete the light absorbing region; and
d) controlling the thickness of the antireflection layer and the light absorbing layer so as to reduce the fraction of incident light which passes through the support and is converted to either transmitted light or reflected light by the light absorbing region.

2. The method according to claim 1 wherein the antireflection layer includes Si, Ge, AlSb, As₂S₃, GaAs, GaP, GaIn, PbTe, PbS, or InP.

3. The method according to claim 1 wherein the light absorbing layer includes Cr, Ni, V, W, Pt, Pd, Ir, or Os.

4. The method according to claim 1 wherein the antireflection layer includes Si and further including controlling the thickness of the antireflection layer by providing a blue light source having a wavelength selected to be partially absorbed when it passes through the Si layer and monitoring the light which passes through the Si layer and producing a first signal which is representative of the thickness of the Si layer and using the first signal to control the amount of Si deposited by the first source.

5. The method according to claim 4 wherein the light absorbing layer includes Cr and further including controlling the thickness of the light absorbing layer by providing a white or a red light source having a spectrum selected to be partially absorbed or partially reflected when it encounters the Cr layer and monitoring the light which passes through or is reflected from the Cr layer and producing a second signal which is representative of the thickness of the Cr layer and using the second signal to control the amount of Cr deposited by the second source.

6. The method according to claim 1 wherein the support coated with the antireflection layer and the light absorbing layer together formed a light absorbing region into a donor substrate roll and packaged in a moisture resisting material or container.

7. The method according to claim 1 further including cutting the donor substrate into sheets and coating said sheets with an organic transfer layer over the light absorbing region of the sheets.
